(19) United States
(12) Patent Application Publication
(10) Pub. No.: US 2005/0055769 A1
(43) Pub. Date: Mar. 17, 2005

(54) Method for moving an invalid patient

(76) Inventor: Gilda A. Taylor, Arden, NC (US)

Correspondence Address: Joseph T. Guy, Ph.D.;NEXSEN PRUET JACOBS & POLLARD, LLC, Fed. Sta., P.O. Box 10107, Greenville, SC, 29603-0107, US

(21) Appl. No.: 10/659,896

(22) Filed: Sep. 11, 2003

(51) Int. Cl. A61G 7/10

(52) U.S. Cl. 5/81.1 T

(57) ABSTRACT

A method for rotating a patient to one side in a bed. The method comprises passing an elongated strap around the patient wherein the strap comprises a lower end and an upper end. Attaching the lower end to a bed rail. Grasping the upper end and pulling the upper end toward the bed rail whereby the patient rolls towards the bed rail.

### BACKGROUND OF THE INVENTION

The present invention relates to a method for moving an invalid patient. More specifically, the present invention relates to a method for rotating a patient in bed or assisting a patient in standing and a device suitable for both.

The health care industry is constantly striving to improve health care. At the forefront of this desire is the improved care of invalid patients. It is widely known that assisting invalid patients to stand, or roll over in a bed, is vital. Patients that can walk, with assistance, yet have difficulty in standing have long been a problem for health care providers. It is very difficult to assist a patient in standing due to the awkward angle at which the assistor must reach. This is difficult on the back and many health care individuals have chronic back soreness due to the continual need to assist patients in standing. The same is true with rolling a patient to their side while in bed. This is often necessary to avoid bedsores or to access certain anatomic features. The assistor must be bent over the patient while at the same time exerting sufficient force to roll the patient to one side. This places a strain on the back of the assistor.

The problems associated with assisting a patient to stand, or roll to one side in bed, are exasperated with obese patients. The extra weight often prohibits all but the strongest of health care workers to assist obese patients. This typically results in a lack of adequate health care for obese patients.

There have been many attempts to alleviate these problems in the art yet none of them have been suitable.

An overhead lift mechanism is described by Heil in U.S. Pat. No. 6,532,607. The lift mechanism comprises a hoist which traverses the area of mobility thereby providing assistance at locations around the area of mobility. This is costly and only suitable for the location in which it is installed. This option would not be suitable for a health care facility due to the large number of units needed and the prohibitive cost.

Harnesses are described by Carroll in U.S. Pat. No. 5,896,859 and Butterfield in U.S. Pat. No. 5,253,657. The harness of Butterfield is helpful yet it would not be sufficient to assist a patient in standing or rolling to one side in a bed. The device of Carroll is helpful yet the use is limited to assisting a patient to stand. Furthermore, the device of Carroll is around the waist thereby causing the assistor to bend at the back to assist the patient. As the patient stands the leg strap limits the ability of the person to straighten completely.

A mechanism to assist in rolling a patient to one side is described by Walker in U.S. Pat. No. 6,560,793. The mechanism of Walker requires that a sheet, with straps attached thereto, be slid under a patient. It would be difficult to slide this large sheet under an obese patient without dislodging the strap. After the sheet is completely under the patient the sheet is pulled towards the side of the bed whereby the patient is encased and rolls in the sheet. If the patient already has bedsores the sheet will aggravate the bedsores since the entire back and sides of the torso of the patient are in contact with the sheet. Furthermore, an obese patient may be difficult to turn since the sheet may slide from under the patient instead of causing the patient to roll. After the patient is turned the strap can be used to immobilize the patient.

Further mechanisms to assist in rolling a patient are described by Wheeler in U.S. Pat. No. 6,393,636. A sheet, placed under the patient, is withdrawn by a ratchet mechanism. This device causes the patient to be drawn towards the mechanism. If the patient rolls to far the medical professional is on the wrong side of the bed to protect the patient from rolling off of the bed or into the bed rail.

The devices of Walker and Wheeler are cumbersome and require set-up prior to use. This is undesirable in an industry where patient care is already suffering due to a lack of adequate assistance. The art has a strong desire for a method of assisting patients in standing and rolling to one side that requires minimal equipment, minimal cost, and which can be used with any patient including obese patients.

A method is provided in the present application meeting those long felt desires in the art.

### BRIEF SUMMARY OF THE INVENTION

It is object of the present invention to provide a method for rolling a patient to one side in the bed.

It is another object of the present invention to provide a method for assisting a patient to stand.

A particular feature is the ability to do both with a single device that has minimal cost, minimal space requirements for storage and which can be used on any patient.

Another particular feature is the ability to assist patients with minimal back strain on the assistor.

These and other advantages, as would be realised to one of ordinary skill in the art, are provided in a method for rotating a patient to one side in a bed. The method comprises passing an elongated strap around the patient wherein the strap comprises a lower end and an upper end. Attaching the lower end to a bed rail. Grasping the upper end and pulling the upper end toward the bed rail whereby the patient rolls towards the bed rail.

Another embodiment is provided in a method for assisting a patient to rise from a sitting position to a standing position. The method comprises the steps of an assistor passes an elongated strip around the patient below the arms and above the waist of the patient. The elongated strip comprises a first end and a second end. The assistor grasps the first end of the elongated strip with a first hand and the second end of the elongated strip with a second hand such that each hand is below the arm of the patient. The patient grasps each arm of the assistor with a hand and as the assistor rises from a crouch position the patient rises to a standing position.

### BRIEF DESCRIPTION OF THE DRAWINGS

FIG. 1 is a view of an embodiment of the present invention wherein an invalid patient is being assisted to stand.

FIG. 2 is a view of an embodiment of the present invention wherein the patient is prepared to be rolled to one side.

FIG. 3 is a view of the embodiment of FIG. 2 after the patient has been rolled to the side.

FIG. 4 is an embodiment of the invention wherein a single strap is employed.

FIG. 5 illustrates a preferred strap of the present invention.

### DETAILED DESCRIPTION OF THE INVENTION

The inventors of the present application have developed, through diligent research, a method for lifting and rotating patients with minimal back strain on the assistor and with the ability to minimize contact with bedsores while assisting.

The invention will be described with reference to the figures forming a part of the present application. In the various figures similar elements are numbered accordingly.

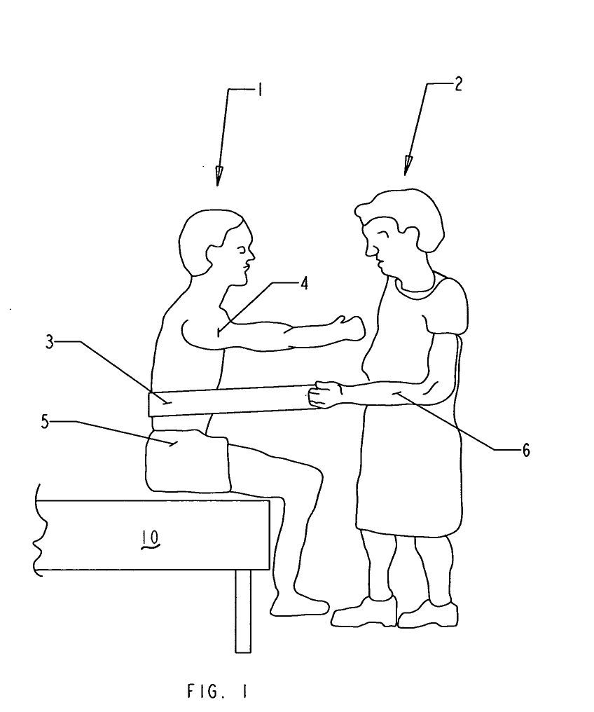

An embodiment of the present invention is illustrated in FIG. 1. In FIG. 1, the patient, 1, is being assisted by an assistor, 2, from a sitting position to a standing position. An elongated strap, 3, is passed around the patient, 1, such that it is below the patients arms, 4, but above the waist, 5. It is desirable for the strap to be as high as possible to minimize the amount of crouching required by the assistor, 2. The assistor grasps each side of the elongated strap thereby forming a “U” around the torso of the patient. The assistors arms, 6, and elongated strap, 3, thereby provide a support structure within which the patient is contained. The assistor is in a partially crouched position and as the assistor rises from the crouch position the patient can stand while still being contained within the support structure formed by the elongated strap and assistors arms.

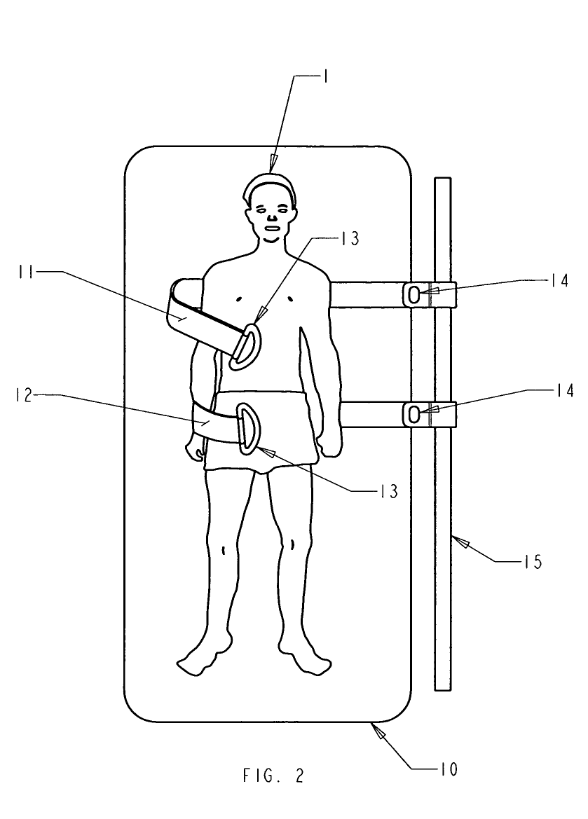

Another embodiment is illustrated in FIG. 2. In FIG. 2, the patient, 1, is lying in a bed, 10. A top strap, 11, and bottom strap, 12, are slid under the patient at the appropriate location. A single strap is sufficient but the use of two straps may be necessary in some instances. The upper end of each strap preferably comprises a handle, 13, in the form of a loop or grasp ring, attached thereto. The grasp ring is optional and the strap can be used with, or without, the grasp ring. In one embodiment the strap has a loop at the end which acts as a handle. At the lower end of the elongated strap is an attachment device, 14, for securing the lower end of the strap to the bed rail, 15. The assistor, not shown, can then pull the handle and upper end of the elongated strap towards the bed rail thereby rotating the patient onto their side closest to the bed rail.

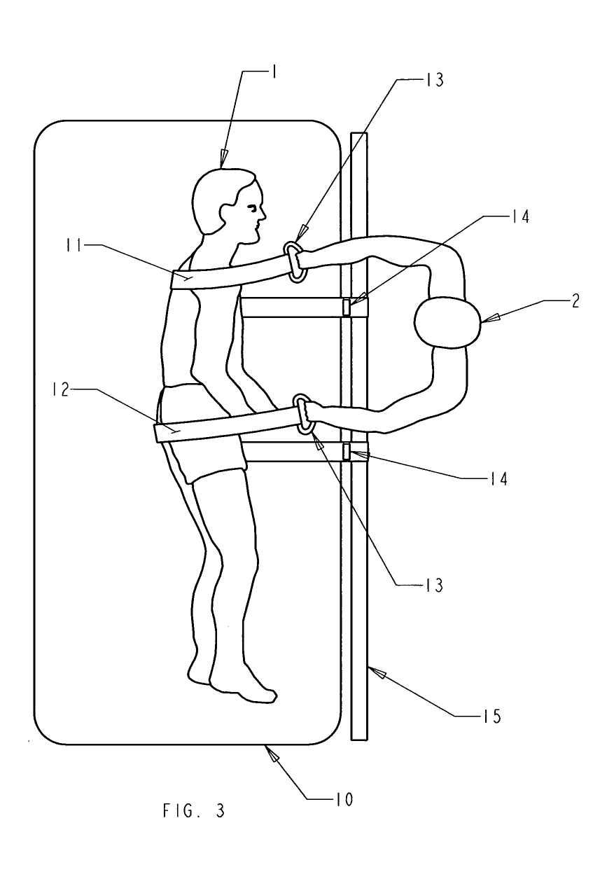

The embodiment of FIG. 2 is illustrated in FIG. 3 after rotation wherein the assistor, 2, has pulled the upper end of the elongated straps, 11 and 12, towards the bed rail, 15, by grasping the handles, 13. The straps are secured to the bed rail, 15, to insure that the straps do not slip on the patient thereby potentially causing abrasions.

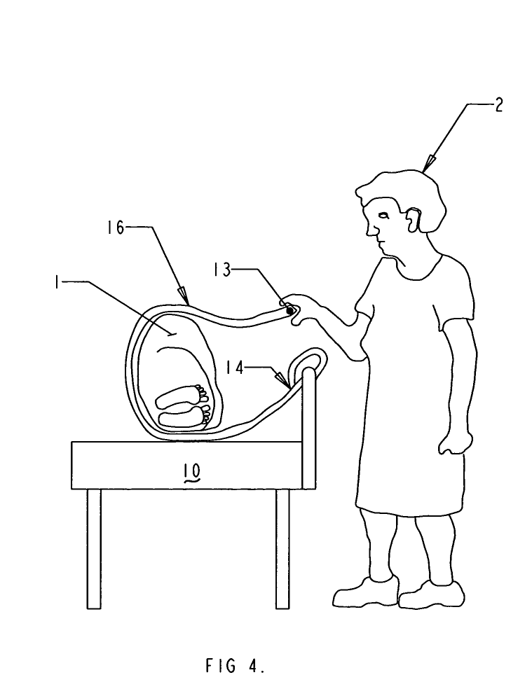

Another embodiment is illustrated in FIG. 4 wherein a single strap, 16, is employed. In FIG. 3, the patient, 1, has been rotated by the assistor, 2, as previously described.

In the embodiment illustrated in FIGS. 2-4, the patient is rolled towards their left side. It would be understood that the patient could be rotated to the right side in an analogous manner.

The location of the strap is dependent on the location of bedsores, the number of straps and the strength of the patient. For extremely weak patients, or those that can not assist in the process of rotation, two straps are desired with one located at approximately the nipple line of the patient and one at approximately the buttocks as illustrated in FIGS. 2 and 3. Patients with upper body mobility may be easily rotated with one strap located at approximately the buttocks. The straps are to be positioned, when possible, in a manner sufficient to avoid as much contact with bedsores as possible without jeopardizing control of the rotation process. Extremely obese patients may require three or more straps yet even with one strap obese patients can be rotated in most instance.

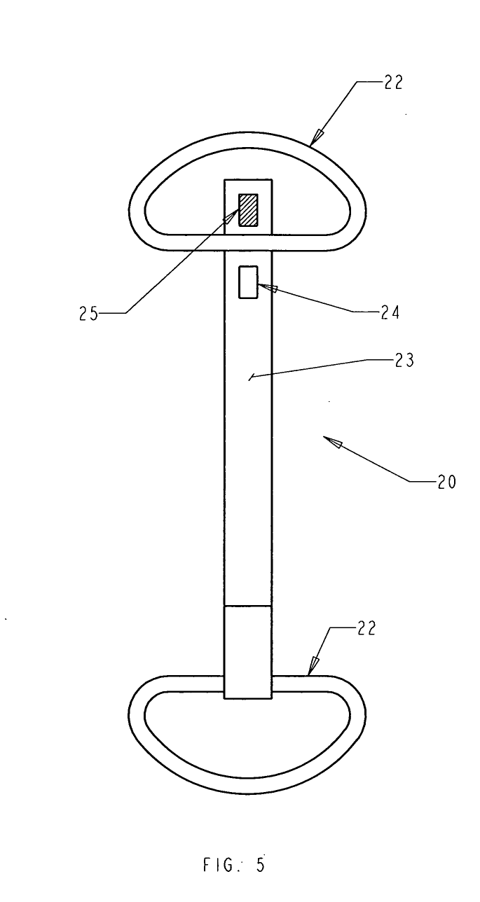

A preferred elongated strap of the present invention is illustrated in FIG. 5. In FIG. 5, the elongated strap, generally represented at 20, comprises an optional removable grip, 22, attached to each end. Each grip is preferably oval to provide adequate grip area. The central portion, 23, of the elongated strap is preferably padded for comfort. Any non-abrasive padding is sufficient with preference being given to natural soft materials such as wools, furs and the like.

A particular feature of the present invention is the ease with which the elongated strap can be stored. The elongated strap can easily be stored in a pocket or on a medical supply cart as typically employed in health care facilities.

Matching attachment elements, 24 and 25, are provided for securing the elongated strap to a bed rail or for securing the removable grip therein. Preferred attachment elements are snaps, with resistively engagable male and female elements, due to the low cost and ease of operation. Hook and loop devices such as Velcro® are also exemplary due to the lateral strength yet ease of vertical separation. Other attachment elements are suitable such as belt and loop, button and button hole, etc. can be employed as can any reversibly attachment element. One end may have a permanent loop, such as with stitching, but one end must be reversible to allow the strap to be secured to a bed rail as described herein.

The invention has been described with particular emphasis on the preferred embodiments. It would be realized from the teachings herein that other embodiments, alterations, and configurations could be employed without departing from the scope of the invention which is more specifically set forth in the claims which are appended hereto.

1. A method for rotating a patient to one side in a bed comprising:
passing an elongated strap around said patient wherein said strap comprises a lower end and an upper end;
attaching said lower end to a bed rail;
grasping said upper end; and
pulling said upper end toward said bed rail whereby said patient rolls towards said bed rail.

2. The method for rotating a patient to one side in a bed of claim 1 wherein said lower end comprises an attachment device.

3. The method for rotating a patient to one side in a bed of claim 2 wherein said attachment device is a snap.

4. The method for rotating a patient to one side in a bed of claim 1 wherein said upper end comprises a handle.

5. The method for rotating a patient to one side in a bed of claim 1 wherein said elongated strap further comprises padding.

6. The method for rotating a patient to one side in a bed of claim 1 further comprising prior to said pulling:
passing a second elongated strap around said patient wherein said second elongated strap comprises a second lower end and a second upper end;
attaching said second lower end to a bed rail; and
grasping said second upper end.

7. The method for rotating a patient to one side in a bed of claim 6 wherein said second lower end comprises a second attachment device.

8. The method for rotating a patient to one side in a bed of claim 7 wherein said second attachment device is a loop and hook device.

9. The method for rotating a patient to one side in a bed of claim 6 wherein said second upper end comprises a handle.

10. The method for rotating a patient to one side in a bed of claim 6 wherein said elongated strap is at a nipple line and said second elongated strap is at a buttocks of said patient.

11. A method for assisting a patient to rise from a sitting position to a standing position comprising the steps of:
an assistor passes an elongated strip around said patient below the arms and above the waist of said patient wherein said elongated strip comprises a first end and a second end;
said assistor grasps said first end of said elongated strip with a first hand and said second end of said elongated strip with a second hand such that each said hand is below the arm of said patient;
said patient grasps each arm of said assistor with a hand;
wherein as said assistor rises from a crouch position said patient rises to a standing position.

12. The method for assisting a patient to rise from a sitting position to a standing position of claim 11 wherein said first end comprises a handle.

13. The method for assisting a patient to rise from a sitting position to a standing position of claim 11 wherein said second end comprises a handle.

14. The method for assisting a patient to rise from a sitting position to a standing position of claim 13 wherein said handle is removable.

15. The method for assisting a patient to rise from a sitting position to a standing position of claim 14 wherein said strap comprises an attachment device.

16. The method for assisting a patient to rise from a sitting position to a standing position of claim 15 wherein said attachment device is a hook and loop device.
